(19) United States
(12) Patent Application Publication
(10) Pub. No.: US 2005/0235951 A1
(43) Pub. Date: Oct. 27, 2005

(54) Air and fuel supply system for combustion engine operating in HCCI mode

(76) Inventors: James R. Weber, Lacon, IL (US); Scott A. Leman, Eureka, IL (US); Gerald N. Coleman, Bulwick (GB); Kevin P. Duffy, Metamora, IL (US); Eric C. Fluga, Dunlap, IL (US); Jonathan P. Kilkenny, Peoria, IL (US); Maarten Verkiel, Metamora, IL (US)

Correspondence Address: CATERPILLAR INC.;100 N.E. ADAMS STREET, PATENT DEPT., PEORIA, IL, 616296490, US

(21) Appl. No.: 10/993,065

(22) Filed: Nov. 19, 2004

Related U.S. Application Data
(63) Continuation-in-part of application No. 10/733,570, filed on Dec. 12, 2003.
Application No. 10/733,570 is a continuation of application No. 10/143,908, filed on May 14, 2002, now Pat. No. 6,688,280.
(63) Continuation-in-part of application No. 10/933,300, filed on Sep. 3, 2004.
Application No. 10/933,300 is a continuation-in-part of application No. 10/733,570, filed on Dec. 12, 2003.
Application No. 10/733,570 is a continuation of application No. 10/143,908, filed on May 14, 2002, now Pat. No. 6,688,280.
(63) Continuation-in-part of application No. 10/928,425, filed on Aug. 27, 2004.

(51) Int. Cl. F02B 3/12

(52) U.S. Cl. 123/299; 60/605.2

(57) ABSTRACT

An engine and a method of operating an internal combustion engine is provided. The method comprises supplying a pressurized air from an intake manifold to an air intake port of a combustion chamber in the cylinder, operating an air intake valve to open the air intake port to allow the pressurized air and exhaust gas mixture to flow between the combustion chamber and the intake manifold during a portion of a compression stroke of the piston, and operating the engine in an HCCI combustion mode. In at least some embodiments, a mixture of pressurized air and recirculated exhaust gas is supplied from an intake manifold to an air intake port of a combustion chamber in the cylinder. In some embodiments, the method further comprises causing an exhaust stream of an engine to contact a NOx adsorber.

This application is a continuation-in-part of application Ser. No. 10/733,570, filed Dec. 12, 2003, which is a continuation of application Ser. No. 10/143,908, filed May 14, 2002, now U.S. Pat. No. 6,688,280; this application is also a continuation-in-part of application Ser. No. 10/933,300, filed Sep. 3, 2004, which is a continuation-in-part of application Ser. No. 10/733,570, filed Dec. 12, 2003, which is a continuation of application Ser. No. 10/143,908, filed May 14, 2002, which is now U.S. Pat. No. 6,688,280; this application is also a continuation-in-part of application Ser. No. 10/928,425, filed Aug. 27, 2004; the content of all of the above are hereby incorporated by reference.

### TECHNICAL FIELD

The present description relates to a combustion engine and, more particularly, to an air and fuel supply system for use with an internal combustion engine operating in homogeneous charge compression ignition (“HCCI”) mode.

### BACKGROUND

Internal combustion engines are used extensively for a variety of purposes. The transportation infrastructure relies almost exclusively on the use of engines to provide power for mobility. Electrical power generation also relies heavily on internal combustion engines.

The prolific use of engines in our society has created a number of issues, one of which is the ever-increasing amount of combustion by-products being emitted. Although today's engines operate with much lower emission levels than previous generations of engines, the rapidly increasing number of engines being used creates the need to reduce emission levels even more.

Governments around the world recognize this problem and are taking regulatory steps to address the emission levels of engines. For example, levels of oxides of nitrogen (“NOx”), hydrocarbons (“HC”), carbon monoxide (“CO”), and smoke, among others, must be reduced drastically to meet evolving government standards.

Spark ignition engines, by the nature of their operation and the types of fuel used, tend to produce low levels of NOx and particulate emissions. Compression ignition engines, for example, diesel engines, generally produce higher levels of NOx and particulate emissions. Diesel engines, however, are still popular in use because they provide higher thermal efficiency than their spark-ignition counterparts, and thus offer higher power output for work applications.

One attempt to reduce the emissions of compression ignition engines has been the use of aftertreatment systems to alter or remove the unwanted emissions from the exhaust of the engines. One form of aftertreatment technology that has shown promise in reducing the NOx emissions of compression ignition engines is NOx adsorber technology, a catalyst technology. Unfortunately, the successful implementation of NOx adsorber technology has proven difficult. First, for sufficient NOx reduction at low temperatures, NOx adsorbers must have very high loadings of expensive noble metals. In fact, NOx adsorbers that operate successfully in low temperature conditions may require as much as twice the noble metal content of NOx adsorbers that only operate in higher temperature conditions. Second, the effectiveness of NOx adsorber technology in very low temperature conditions is questionable. To improve performance in these conditions, expensive and fuel intensive thermal management may be necessary. Third, the catalyst of a NOx adsorber is poisoned by sulfur, even at the current ultra low sulfur levels in fuel. This poisoning process reduces the overall lifespan of the catalyst.

Another attempt to reduce the emissions of compression ignition engines has been the use of HCCI combustion. Engines that operate in HCCI mode have generated much interest due to the potential to operate at high fuel efficiency while generating low combustion emissions. HCCI engines differ from conventional diesel compression ignition engines in that diesel engines ignite fuel that is rich, i.e., highly concentrated, in an area in a combustion chamber, while HCCI techniques create a dispersed homogeneous fuel/air mixture by the time of combustion. Combustion of a homogeneous fuel/air mixture allows an engine to operate such that emission by-products are significantly reduced. Unfortunately, successful implementation of HCCI combustion at all engine load conditions has proven difficult. At high engine load conditions, HCCI combustion causes high mechanical loading of engine parts due to a higher peak cylinder pressure than traditional diesel combustion. Engine components having commonly used material compositions may not be able to withstand these higher pressures. Also, in order to control the timing of HCCI combustion in higher load conditions, significant structural changes may need to be made to the engine, including, for example, mechanisms for varying the compression ratio of the engine.

Early or late closing of the intake valve, referred to as the “Miller Cycle,” may reduce the effective compression ratio of the cylinder, which in turn reduces compression temperature, while maintaining a high expansion ratio. Consequently, a Miller cycle engine may have improved thermal efficiency and reduced exhaust emissions of NOₓ. In a conventional Miller cycle engine, the timing of the intake valve close is typically shifted slightly forward or backward from that of the typical Otto cycle engine. For example, in the Miller cycle engine, the intake valve may remain open until the beginning of the compression stroke.

An internal combustion engine using the Miller cycle may also include one or more turbochargers for compressing a fluid, which is supplied to one or more combustion chambers within corresponding combustion cylinders. Each turbocharger typically includes a turbine driven by exhaust gases of the engine and a compressor driven by the turbine. The compressor receives the fluid to be compressed and supplies the compressed fluid to the combustion chambers. The fluid compressed by the compressor may be in the form of combustion air or an air/fuel mixture.

An internal combustion engine may also include a supercharger arranged in series with a turbocharger compressor of an engine. U.S. Pat. No. 6,273,076 (Beck et al., issued Aug. 14, 2001) discloses a supercharger having a turbine that drives a compressor to increase the pressure of air flowing to a turbocharger compressor of an engine. In some situations, the air charge temperature may be reduced below ambient air temperature by an early closing of the intake valve.

While a turbocharger may utilize some energy from the engine exhaust, the series supercharger/turbocharger arrangement does not utilize energy from the turbocharger exhaust. Furthermore, the supercharger requires an additional energy source.

The present description is directed to overcoming one or more of the problems as set forth above.

### SUMMARY

According to one aspect, a method of operating an internal combustion engine, including at least one cylinder and a piston slidable in the cylinder, is provided. The method comprises supplying a pressurized air from an intake manifold to an air intake port of a combustion chamber in the cylinder, operating an air intake valve to open the air intake port to allow the pressurized air and exhaust gas mixture to flow between the combustion chamber and the intake manifold during a portion of a compression stroke of the piston, and operating the engine in an HCCI combustion mode.

In at least some embodiments, a mixture of pressurized air and recirculated exhaust gas is supplied from an intake manifold to an air intake port of a combustion chamber in the cylinder.

In further embodiments, the method further comprises causing an exhaust stream of the engine to contact a NOx adsorber.

It is to be understood that both the foregoing general description and the following detailed description are explanatory only and are not restrictive.

### BRIEF DESCRIPTION OF THE DRAWINGS

The accompanying drawings, which are incorporated in and constitute a part of this specification, illustrate several embodiments of the description and, together with the description, serve to explain the principles of the description. In the drawings,

FIG. 1 is a combination diagrammatic and schematic illustration of an air supply system for an internal combustion engine in accordance with the description;

FIG. 2 is a combination diagrammatic and schematic illustration of an engine cylinder in accordance with the description;

FIG. 3 is a diagrammatic sectional view of the engine cylinder of FIG. 2;

FIG. 4 is a graph illustrating an intake valve actuation as a function of engine crank angle in accordance with the present description;

FIG. 5 is a graph illustrating an fuel injection as a function of engine crank angle in accordance with the present description;

FIG. 6 is a combination diagrammatic and schematic illustration of another air supply system for an internal combustion engine in accordance with the description;

FIG. 7 is a combination diagrammatic and schematic illustration of yet another air supply system for an internal combustion engine in accordance with the description;

FIG. 8 is a combination diagrammatic and schematic illustration of an exhaust gas recirculation system included as part of an internal combustion engine in accordance with the description;

FIG. 9 is a schematic depiction of an internal combustion engine;

FIG. 10 is a flow diagram of a method of operation of the engine of FIG. 9; and

FIG. 11 is a graph of combustion modes of the engine of FIG. 9 as a function of engine load and engine speed.

### DETAILED DESCRIPTION

Reference will now be made in detail to embodiments, examples of which are illustrated in the accompanying drawings. Wherever possible, the same reference numbers will be used throughout the drawings to refer to the same or like parts.

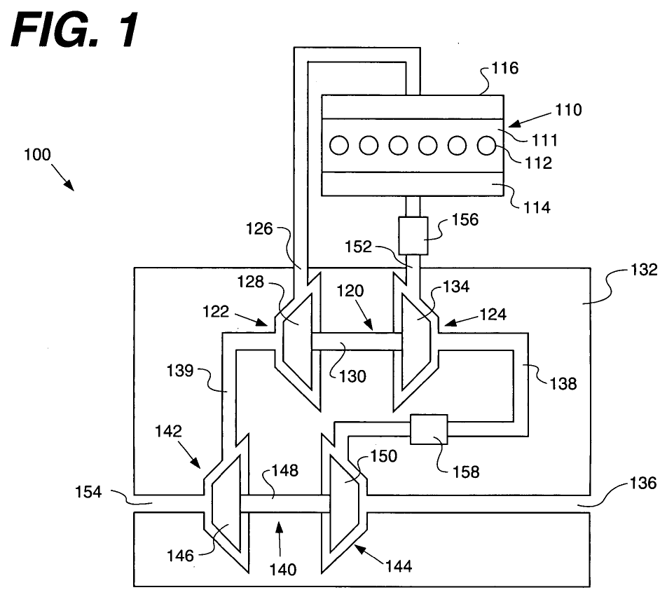

Referring to FIG. 1, an air supply system 100 for an internal combustion engine 110, for example, a four-stroke, diesel engine, is provided. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.

The air supply system 100 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 may include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4:1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 100 may include an air cooler 156, for example, an aftercooler, between the compressor 124 and the intake manifold 114. The air cooler 156 may extract heat from the air to lower the intake manifold temperature and increase the air density. Optionally, the air supply system 100 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 100 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

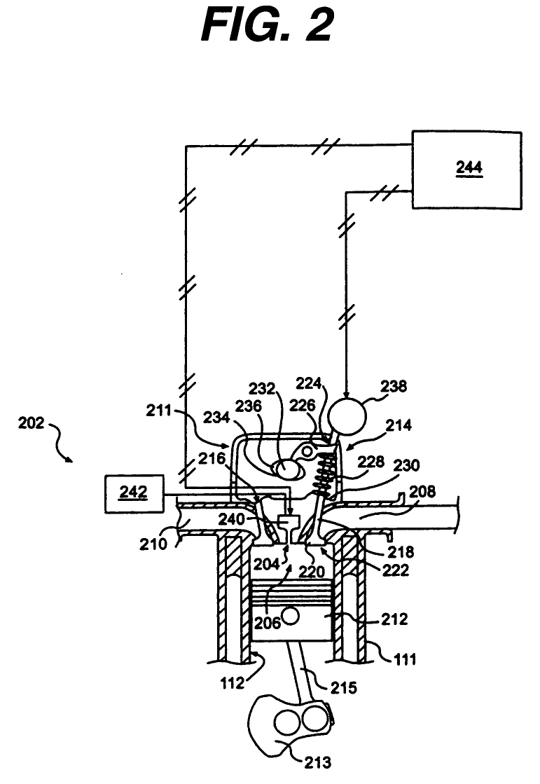

Referring now to FIG. 2, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 540°.

The cylinder 112 may include at least one intake port 208 and at least one exhaust port 210, each opening to the combustion chamber 206. The intake port 208 may be opened and closed by an intake valve assembly 214, and the exhaust port 210 may be opened and closed by an exhaust valve assembly 216. The intake valve assembly 214 may include, for example, an intake valve 218 having a head 220 at a first end 222, with the head 220 being sized and arranged to selectively close the intake port 208. The second end 224 of the intake valve 218 may be connected to a rocker arm 226 or any other conventional valve-actuating mechanism. The intake valve 218 may be movable between a first position permitting flow from the intake manifold 114 to enter the combustion cylinder 112 and a second position substantially blocking flow from the intake manifold 114 to the combustion cylinder 112. A spring 228 may be disposed about the intake valve 218 to bias the intake valve 218 to the second, closed position.

A camshaft 232 carrying a cam 234 with one or more lobes 236 may be arranged to operate the intake valve assembly 214 cyclically based on the configuration of the cam 234, the lobes 236, and the rotation of the camshaft 232 to achieve a desired intake valve timing. The exhaust valve assembly 216 may be configured in a manner similar to the intake valve assembly 214 and may be operated by one of the lobes 236 of the cam 234. In an embodiment, the intake lobe 236 may be configured to operate the intake valve 218 in a conventional Otto or diesel cycle, whereby the intake valve 218 moves to the second position from between about 10° before bottom dead center of the intake stroke and about 10° after bottom dead center of the compression stroke. Alternatively, the intake valve assembly 214 and/or the exhaust valve assembly 216 may be operated hydraulically, pneumatically, electronically, or by any combination of mechanics, hydraulics, pneumatics, and/or electronics.

The intake valve assembly 214 may include a variable intake valve closing mechanism 238 structured and arranged to selectively interrupt cyclical movement of and extend the closing timing of the intake valve 218. The variable intake valve closing mechanism 238 may be operated hydraulically, pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 enables the engine 110 to operate under a conventional Otto or diesel cycle or under a variable late-closing Miller cycle.

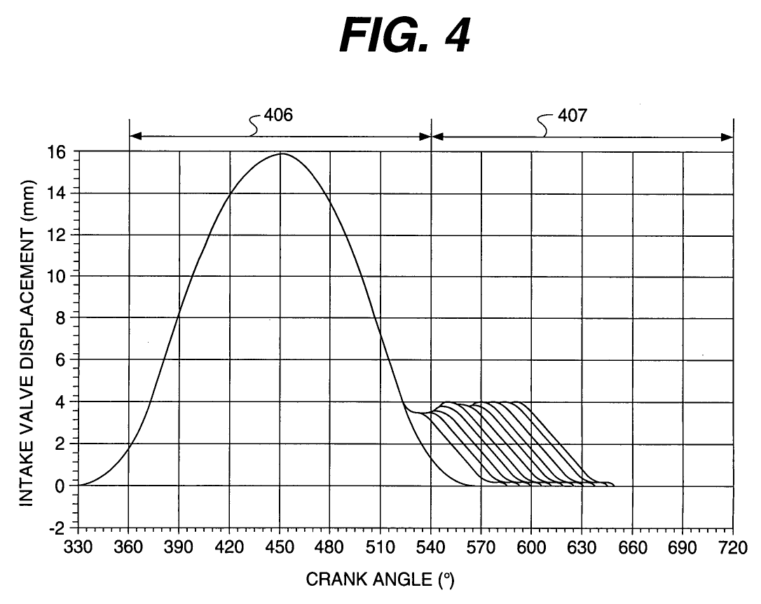

As shown in FIG. 4, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crank shaft is at or near a bottom dead center position of a compression stroke 407, to about 650° crank angle, that is, about 70° before top center of the combustion stroke 508. Thus, the intake valve 218 may be held open for a majority portion of the compression stroke 407, that is, for the first half of the compression stroke 407 and a portion of the second half of the compression stroke 407.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 and/or the fuel injector assembly 240 based on one or more engine conditions, for example, engine speed, load, pressure, and/or temperature in order to achieve a desired engine performance. It should be appreciated that the functions of the controller 244 may be performed by a single controller or by a plurality of controllers. Similarly, spark timing in a natural gas engine may provide a similar function to fuel injector timing of a compression ignition engine.

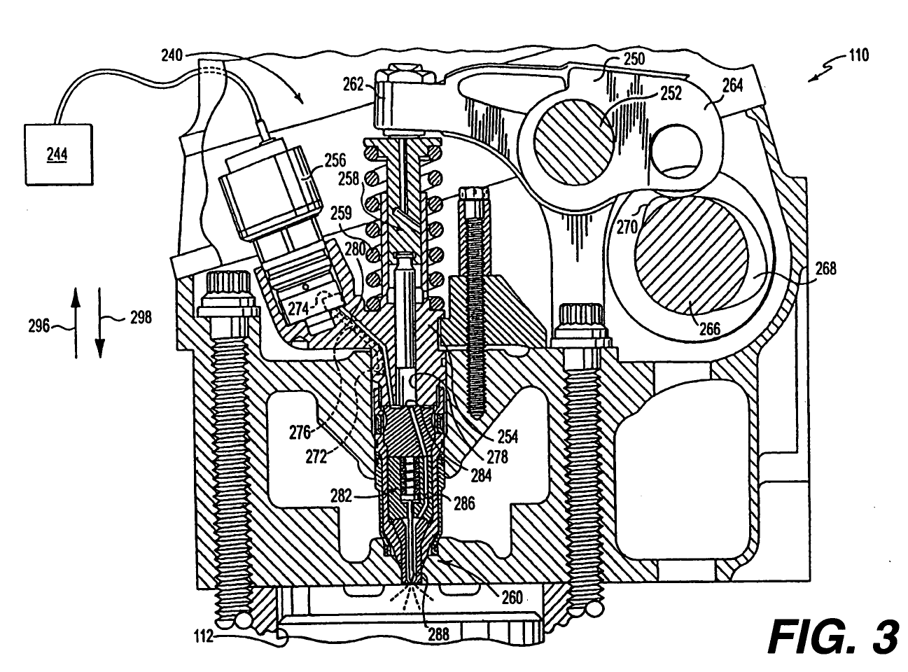

Referring now to FIG. 3, each fuel injector assembly 240 may be associated with an injector rocker arm 250 pivotally coupled to a rocker shaft 252. Each fuel injector assembly 240 may include an injector body 254, a solenoid 256, a plunger assembly 258, and an injector tip assembly 260. A first end 262 of the injector rocker arm 250 may be operatively coupled to the plunger assembly 258. The plunger assembly 258 may be biased by a spring 259 toward the first end 262 of the injector rocker arm 250 in the general direction of arrow 296.

A second end 264 of the injector rocker arm 250 may be operatively coupled to a camshaft 266. More specifically, the camshaft 266 may include a cam lobe 267 having a first bump 268 and a second bump 270. The camshafts 232, 266 and their respective lobes 236, 267 may be combined into a single camshaft (not shown) if desired. The bumps 268, 270 may be moved into and out of contact with the second end 264 of the injector rocker arm 250 during rotation of the camshaft 266. The bumps 268, 270 may be structured and arranged such that the second bump 270 may provide a pilot injection of fuel at a predetermined crank angle before the first bump 268 provides a main injection of fuel. It should be appreciated that the cam lobe 267 may have only a first bump 268 that injects all of the fuel per cycle.

When one of the bumps 268, 270 is rotated into contact with the injector rocker arm 250, the second end 264 of the injector rocker arm 250 is urged in the general direction of arrow 296. As the second end 264 is urged in the general direction of arrow 296, the rocker arm 250 pivots about the rocker shaft 252 thereby causing the first end 262 to be urged in the general direction of arrow 298. The force exerted on the second end 264 by the bumps 268, 270 is greater in magnitude than the bias generated by the spring 259, thereby causing the plunger assembly 258 to be likewise urged in the general direction of arrow 298. When the camshaft 266 is rotated beyond the maximum height of the bumps 268, 270, the bias of the spring 259 urges the plunger assembly 258 in the general direction of arrow 296. As the plunger assembly 258 is urged in the general direction of arrow 296, the first end 262 of the injector rocker arm 250 is likewise urged in the general direction of arrow 296, which causes the injector rocker arm 250 to pivot about the rocker shaft 252 thereby causing the second end 264 to be urged in the general direction of arrow 298.

The injector body 254 defines a fuel port 272. Fuel, such as diesel fuel, may be drawn or otherwise aspirated into the fuel port 272 from the fuel rail 242 when the plunger assembly 258 is moved in the general direction of arrow 296. The fuel port 272 is in fluid communication with a fuel valve 274 via a first fuel channel 276. The fuel valve 274 is, in turn in fluid communication with a plunger chamber 278 via a second fuel channel 280.

The solenoid 256 may be electrically coupled to the controller 244 and mechanically coupled to the fuel valve 274. Actuation of the solenoid 256 by a signal from the controller 244 may cause the fuel valve 274 to be switched from an open position to a closed position. When the fuel valve 274 is positioned in its open position, fuel may advance from the fuel port 272 to the plunger chamber 278, and vice versa. However, when the fuel valve 274 is positioned in its closed positioned, the fuel port 272 is isolated from the plunger chamber 278.

The injector tip assembly 260 may include a check valve assembly 282. Fuel may be advanced from the plunger chamber 278, through an inlet orifice 284, a third fuel channel 286, an outlet orifice 288, and into the cylinder 112 of the engine 110.

Thus, it should be appreciated that when one of the bumps 268, 270 is not in contact with the injector rocker arm 16, the plunger assembly 258 is urged in the general direction of arrow 296 by the spring 259 thereby causing fuel to be drawn into the fuel port 272 which in turn fills the plunger chamber 278 with fuel. As the camshaft 266 is further rotated, one of the bumps 268, 270 is moved into contact with the rocker arm 250, thereby causing the plunger assembly 258 to be urged in the general direction of arrow 298. If the controller 244 is not generating an injection signal, the fuel valve 274 remains in its open position, thereby causing the fuel that is in the plunger chamber 278 to be displaced by the plunger assembly 258 through the fuel port 272. However, if the controller 244 is generating an injection signal, the fuel valve 274 is positioned in its closed position thereby isolating the plunger chamber 278 from the fuel port 272. As the plunger assembly 258 continues to be urged in the general direction of arrow 298 by the camshaft 266, fluid pressure within the fuel injector assembly 240 increases. At a predetermined pressure magnitude, for example, at about 5500 psi (38 MPa), fuel is injected into the cylinder 112. Fuel will continue to be injected into the cylinder 112 until the controller 244 signals the solenoid 256 to return the fuel valve 274 to its open position.

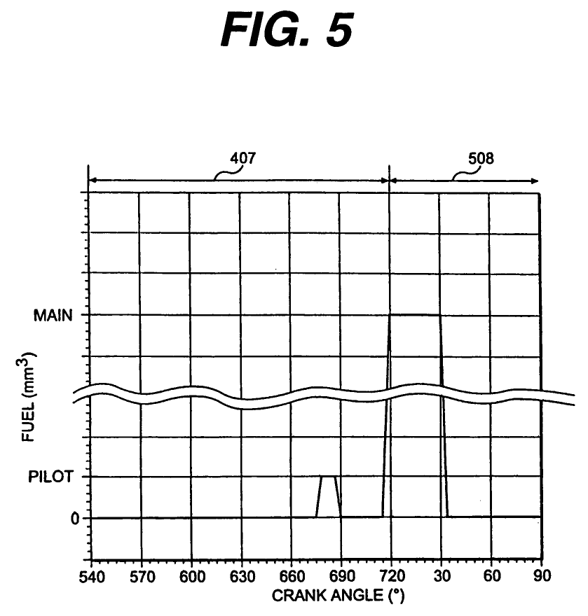

As shown in the graph of FIG. 5, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 10° before top dead center of the compression stroke 407 and about 45° after commencement of the pilot injection. Generally, the pilot injection may commence when the crankshaft 213 is about 40-50° before top dead center of the compression stroke 407 and may last for about 10-15° crankshaft rotation. The main injection may commence when the crankshaft 213 is between about 10° before top dead center of the compression stroke 407 and about 12° after top dead center of the combustion stroke 508. The main injection may last for about 20-45° crankshaft rotation. The pilot injection may use a desired portion of the total fuel used, for example about 10%.

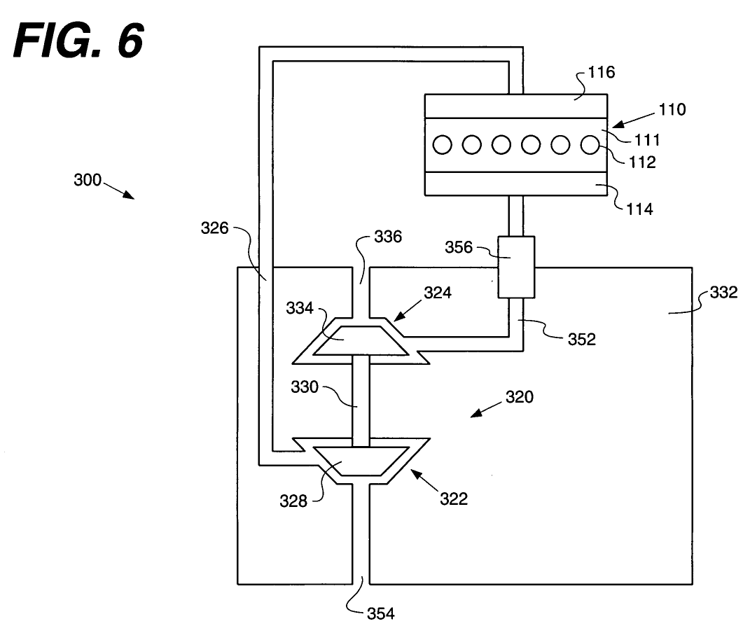

FIG. 6 is a combination diagrammatic and schematic illustration of a second air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake manifold 114.

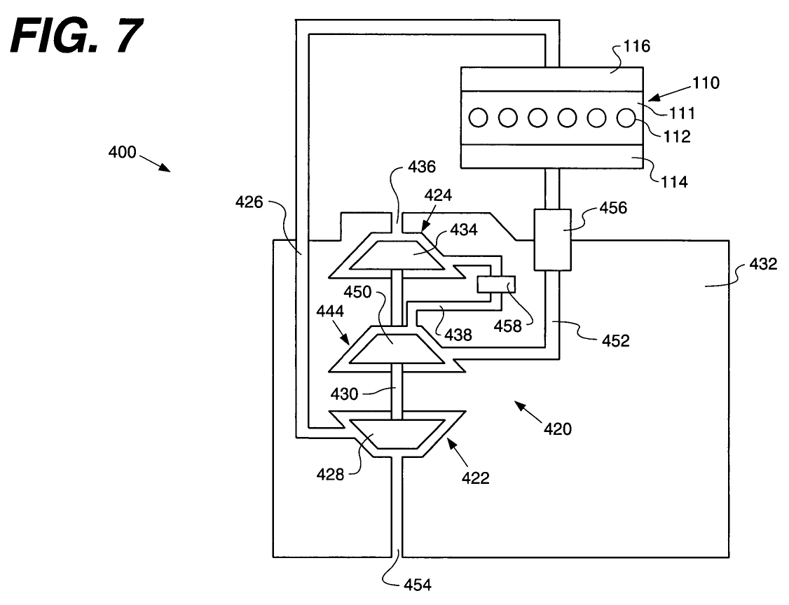

FIG. 7 is a combination diagrammatic and schematic illustration of a third air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4:1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

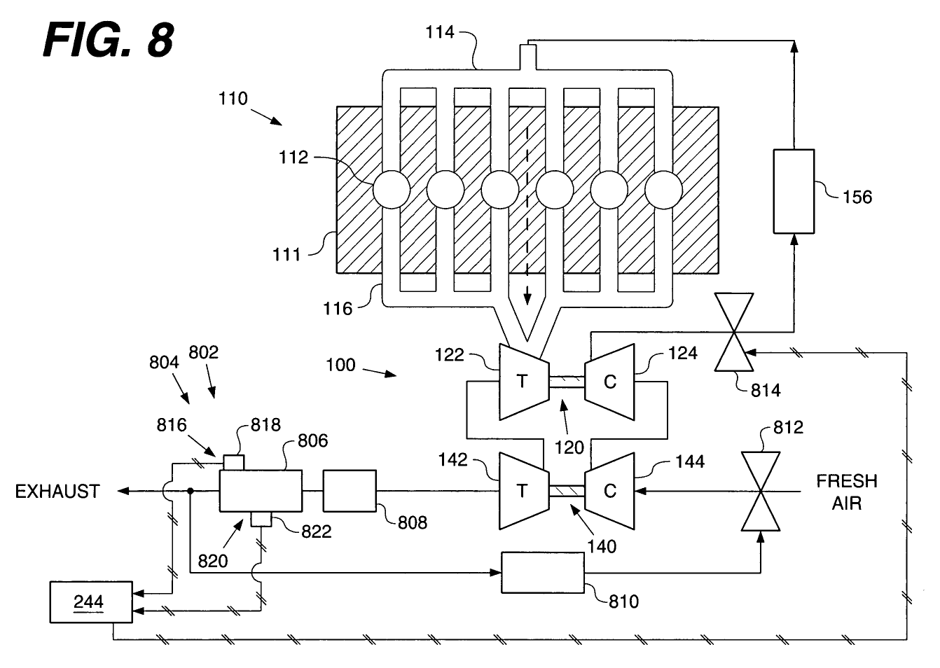

Referring to FIG. 8, an exhaust gas recirculation (“EGR”) system 804 in an exhaust system 802 in a combustion engine 110 is shown. Combustion engine 110 includes intake manifold 114 and exhaust manifold 116. Engine block 111 provides housing for at least one cylinder 112. FIG. 8 depicts six cylinders 112. However, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 8, the air supply system 100 is shown as a two-stage turbocharger system. Air supply system 100 includes first turbocharger 120 having turbine 122 and compressor 124. Air supply system 100 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation. Other types of turbocharger systems, such as a high pressure ratio single-stage turbocharger system, a variable geometry turbocharger system, and the like, may be used instead.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 8 is typical of a low pressure EGR system in an internal combustion engine. Variations of the EGR system 804 may be equally used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De-NOₓ catalyst to further reduce NOₓ emissions. A particulate matter (“PM”) filter 806 receives exhaust gases from oxidation catalyst 808. Although oxidation catalyst 808 and PM filter 806 are shown as separate items, they may alternatively be combined into one package.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120,140. EGR cooler 810 may be of a type well known in the art, for example a jacket water or an air to gas heat exchanger type.

A means 816 for determining pressure within the PM filter 806 is shown. In the preferred embodiment, the means 816 for determining pressure includes a pressure sensor 818. However, other alternate means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. Preferably, the means 820 for determining flow of exhaust gases includes a flow sensor 822. The flow sensor 822 may be used alone to determine pressure in the PM filter 806 based on changes in flow of exhaust gases, or may be used in conjunction with the pressure sensor 818 to provide more accurate pressure change determinations.

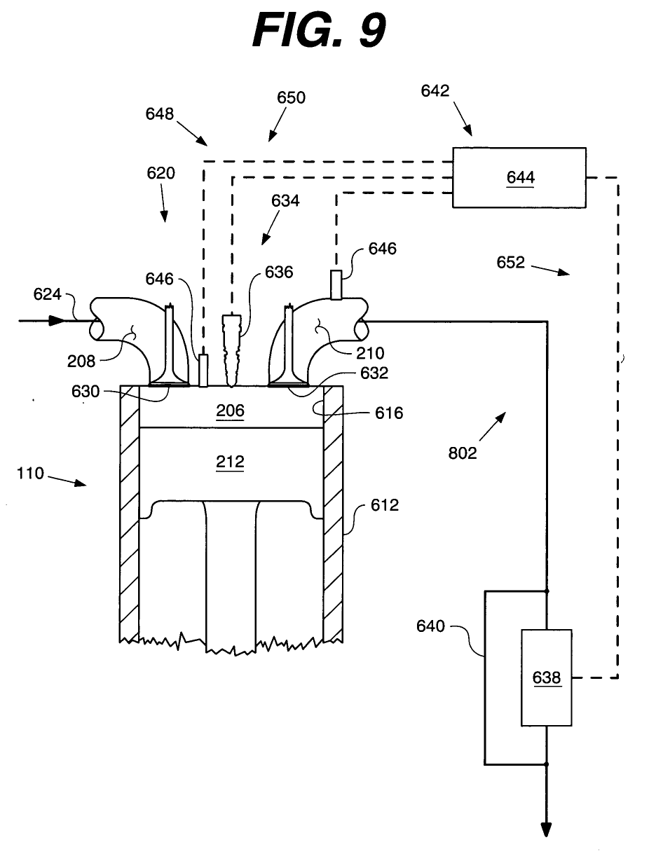

Referring to FIG. 9, there is shown a schematic depiction of an internal combustion engine 110. The engine 110 includes an engine body 612 defining a combustion chamber 206. The engine body 612 may include a cylinder block (not shown) and a cylinder head (not shown) attached to the cylinder block, or other engine structures known in the art. The engine body 612 defines a cylinder 616 within which a piston 212 is disposed. The piston 212 is in contact with the combustion chamber 206. The engine 110 also includes an intake system 620 for delivering intake air or a combination of intake air and fuel to the combustion chamber 206 and an exhaust system 802 permitting an exhaust stream to exit the combustion chamber 206. Although only one cylinder 616 is illustrated in FIG. 9, the present description may be utilized in internal combustion engines 110 of various configurations including engines 110 having any number of cylinders 616, for example, four, five, six, eight, ten, twelve or sixteen cylinders 616. In addition, although the engine 110 is primarily discussed with reference to a four-stroke engine 110, in another embodiment the engine 110 may be in the form of a two-stroke engine 110.

In the embodiment of FIG. 9, the intake system 620 includes an intake manifold 624 and an intake port 208 for directing intake air or an air/fuel mixture into the combustion chamber 206. Likewise, the exhaust system 802 includes an exhaust port 210 for directing exhaust gas as described hereinbelow. One or more intake valves 630 and one or more exhaust valves 632 are positioned in the respective ports, 208 and 210, and moved between open and closed positions by a conventional valve control system, or a variable valve timing system, to control the flow of intake air or air/fuel mixture into, and the exhaust stream out of, the combustion chamber 206, respectively.

The engine 110 has a fuel system 634 connected to the engine body 612. In the embodiment of FIG. 9, the fuel system 634 includes a fuel injector 636 for injecting fuel into the combustion chamber 206. The fuel system 634 is adapted to deliver a diesel fuel charge into the combustion chamber 206. The delivery of a diesel fuel charge typically includes the direct injection of a quantity of fuel into the combustion chamber 206 when the piston 212 is near a top dead center position. The delivery of a diesel fuel charge may include any other method that results in combustion via compression ignition of a highly concentrated area of fuel within the combustion chamber 206 creating a self-propagating flame front.

The fuel system 634 is also adapted to deliver an HCCI fuel charge into the combustion chamber 206. The delivery of an HCCI charge may include delivering an early pilot quantity of fuel into the combustion chamber 206, i.e. injecting a quantity of fuel into the combustion chamber 206 prior to the piston 18 reaching the top dead center position. The delivery of an HCCI charge may include delivering a first quantity of fuel into the combustion chamber 206 at a first angle of dispersion and delivering a second quantity of fuel into the combustion chamber 206 at a second angle of dispersion. The delivery of an HCCI charge may include creating a substantially homogeneous mixture of air and fuel outside of the combustion chamber 206 and then delivering the homogeneous mixture into the combustion chamber 206. The creation of the homogeneous mixture may be accomplished by injecting fuel into the intake manifold 624 of the engine 110 or at the intake port 208 of the engine 110. The delivery of an HCCI charge may include any combination of these methods, or any other method capable of producing within the combustion chamber 206 prior to combustion a combustible mixture, the majority of which is ignitable by compression ignition without the presence of a self-propagating flame front. The fuel system 634 may also be adapted to deliver any other type of fuel charge into the combustion chamber 206.

The engine 110 is adapted to selectively operate in a first combustion mode and a second combustion mode. The engine 110 may also be adapted to operate in one or more additional combustion modes. In one embodiment, the first combustion mode is an HCCI combustion mode, i.e., the mode in which the fuel system 634 delivers an HCCI fuel charge to the combustion chamber 206. The second combustion made may be a diesel combustion mode, i.e., the mode in which the fuel system 634 delivers a diesel charge to the combustion chamber 206.

The engine 110 includes at least one NOx adsorber 638 positioned to contact the exhaust stream of the engine 110. In one embodiment, the NOx adsorber 638 is positioned to be in contact with the exhaust stream substantially only when the exhaust stream is the result of combustion of a type of fuel charge other than an HCCI fuel charge. In another embodiment, the NOx adsorber 638 is positioned to be in contact with the exhaust stream during each combustion mode of the engine 110. The exhaust system 802 may include a bypass path 640 that enables the exhaust stream to be routed around the NOx adsorber 638. As used herein, the term “NOx adsorber” means any structure, technology, or system capable of storing NOx from the exhaust stream of the engine 110 for a limited time and, after a certain portion of a NOx storage capacity is filled, converting some or all of the stored NOx into nitrogen.

The engine 110 also includes a control system 642, which includes an electronic control unit (“ECU”) 644. The control system 642 includes at least one sensor 646 adapted to sense a condition of the engine 110 and report the condition to the ECU 644. The at least one sensor 646 may be located upstream, downstream, or at least partially within the NOx adsorber 638. In one embodiment, the at least one sensor 646 is adapted to sense a load condition of the engine 110. In other embodiments, the at least one sensor 646 may be adapted to sense a speed condition, a temperature condition, or some other condition that would aid the control system 642 in effectively controlling combustion of the engine 110. The control system 642 is capable of processing the information from the at least one sensor 646 and providing control signals to the appropriate engine components to effectively control operation of the engine 110 during each of the combustion modes and to achieve effective and efficient transfer of engine operation between the combustion modes. The control system 642 is also capable of processing the information from the at least one sensor 646 and providing control signals to the appropriate engine components to effectively control regeneration cycles of the NOx adsorber 638. The control system 642 is adapted to select between, and instruct the fuel system 634 to deliver, an HCCI fuel charge and other types of fuel charges, including a diesel fuel charge. This selection by the control system 642 may be in response to the report of the engine condition provided by the at least one sensor 646.

The engine 110 includes a means for operating 648 the engine 110 in the first combustion mode. The means for operating 648 may include the fuel system 634, the control system 642, and/or other structures that enable the engine 110 to operate in the first combustion mode. The engine 110 also includes a means for switching 650 operation of the engine 110 to the second combustion mode. The means for switching 650 may include the control system 642, the ECU 644, the at least one sensor 646 and/or other structures that enable the engine 110 to switch from the first combustion mode to the second combustion mode. The engine 110 includes a means for directing 652 the exhaust stream into contact with the NOx adsorber 638 substantially only during operation of the engine 110 in the second combustion mode. The means for directing 652 may include the exhaust system 802, the exhaust port, 210, the bypass path 640, and/or other structures that enable the engine 110 to place the NOx adsorber 638 into contact with the exhaust stream substantially only during the second combustion mode.

### INDUSTRIAL APPLICABILITY

During use, the internal combustion engine 110 operates in a known manner using, for example, the diesel principle of operation. Referring to the air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The fuel supply system 200 and cylinder 112 shown in FIG. 2 may be used with each of the air supply systems 100, 300, 400. Compressed air is supplied to the combustion chamber 206 via the intake port 208, and exhaust air exits the combustion chamber 206 via the exhaust port 210. The intake valve assembly 214 and the exhaust valve assembly 216 may be controllably operated to direct airflow into and out of the combustion chamber 206.

In a conventional Otto or diesel cycle mode, the intake valve 218 moves from the second position to the first position in a cyclical fashion to allow compressed air to enter the combustion chamber 206 of the cylinder 112 at near top center of the intake stroke 406 (about 360° crank angle), as shown in FIG. 4. At near bottom dead center of the compression stroke (about 540° crank angle), the intake valve 218 moves from the first position to the second position to block additional air from entering the combustion chamber 206. Fuel may then be injector from the fuel injector assembly 240 at near top dead center of the compression stroke (about 720° crank angle).

In a conventional Miller cycle engine, the conventional Otto or diesel cycle is modified by moving the intake valve 218 from the first position to the second position at either some predetermined time before bottom dead center of the intake stroke 406 (i.e., before 540° crank angle) or some predetermined time after bottom dead center of the compression stroke 407 (i.e., after 540° crank angle). In a conventional late-closing Miller cycle, the intake valve 218 is moved from the first position to the second position during a first portion of the first half of the compression stroke 407.

The variable intake valve closing mechanism 238 enables the engine 110 to be operated in both a late-closing Miller cycle and a conventional Otto or diesel cycle. Further, injecting a substantial portion of fuel after top dead center of the combustion stroke 508, as shown in FIG. 5, may reduce NOₓ emissions and increase the amount of energy rejected to the exhaust manifold 116 in the form of exhaust fluid. Use of a high-efficiency turbocharger 320, 420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying movement of the intake valve 218 from the first position to the second position may reduce the compression temperature in the combustion chamber 206. The reduced compression temperature may further reduce NOₓ emissions.

The controller 244 may operate the variable intake valve closing mechanism 238 to vary the timing of the intake valve assembly 214 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying closing of the intake valve assembly 214, the controller 244 may control the cylinder pressure during the compression stroke of the piston 212. For example, late closing of the intake valve reduces the compression work that the piston 212 must perform without compromising cylinder pressure and while maintaining a standard expansion ratio and a suitable air/fuel ratio.

The high pressure air provided by the air supply systems 100, 300, 400 may provide extra boost on the induction stroke of the piston 212. The high pressure may also enable the intake valve assembly 214 to be closed even later than in a conventional Miller cycle engine. In the present description, the intake valve assembly 214 may remain open until the second half of the compression stroke of the piston 212, for example, as late as about 80° to 70° before top dead center (“BTDC”). While the intake valve assembly 214 is open, air may flow between the chamber 206 and the intake manifold 114. Thus, the cylinder 112 experiences less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 100, 300, 400, which may efficiently extract additional work from the exhaust energy.

Referring to the air supply system 100 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 100, and not simply more power

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

Referring again to FIG. 8, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (“CDPF”) or an active diesel particulate filter (“ADPF”). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ to particulate matter, i.e., soot, is within a certain range, for example, from about 20 to 1 to about 30 to 1. It has been found, however, that an EGR system combined with the above described methods of multiple fuel injections and variable valve timing results in a NOₓ to soot ratio of about 10 to 1. Thus, it may be desirable to periodically adjust the levels of emissions to change the NOₓ to soot ratio to a more desired range and then initiate regeneration. Examples of methods that may be used include adjusting the EGR rate and adjusting the timing of main fuel injection.

A venturi (not shown) may be used at the EGR entrance to the fresh air inlet. The venturi would depress the pressure of the fresh air at the inlet, thus allowing EGR to flow from the exhaust to the intake side. The venturi may include a diffuser portion that would restore the fresh air to near original velocity and pressure prior to entry into compressor 144. The use of a venturi and diffuser may increase engine efficiency.

An air and fuel supply system for an internal combustion engine in accordance with the embodiments may extract additional work from the engine's exhaust. The system may also achieve fuel efficiency and reduced NOₓ emissions, while maintaining work potential and ensuring that the system reliability meets with operator expectations.

During operation of the engine 110, the engine 110 selectively operates in different combustion modes. In one embodiment of a method of operation of the engine 110, the NOx adsorber 638 is placed into contact with the exhaust stream only during certain combustion modes. In one method, the engine 110 operates in a first combustion mode. The exhaust stream exits the combustion chamber 206 and does not contact the NOx adsorber 638. The operation of the engine 110 is then switched to a second combustion mode. The switching process may be a direct transition from the first combustion mode to the second combustion mode, or the engine 110 may operate in one or more other combustion modes between the first combustion mode and the second combustion mode, including a partial-HCCI combustion mode, i.e., a combustion mode in which combustion consists of the combustion of a partial HCCI fuel charge and a conventional diesel fuel charge. In one embodiment of the method, the exhaust stream is directed into contact with the NOx adsorber 638 substantially only when the engine 110 is operating in the second combustion mode. In another embodiment, the exhaust stream of the engine 110 is directed into contact with the NOx adsorber 638 during any combustion mode other than the first combustion mode. In one embodiment of the method, the first combustion mode is the HCCI combustion mode. The second combustion mode is not the HCCI combustion mode. For example, the second combustion mode may be the diesel combustion mode.

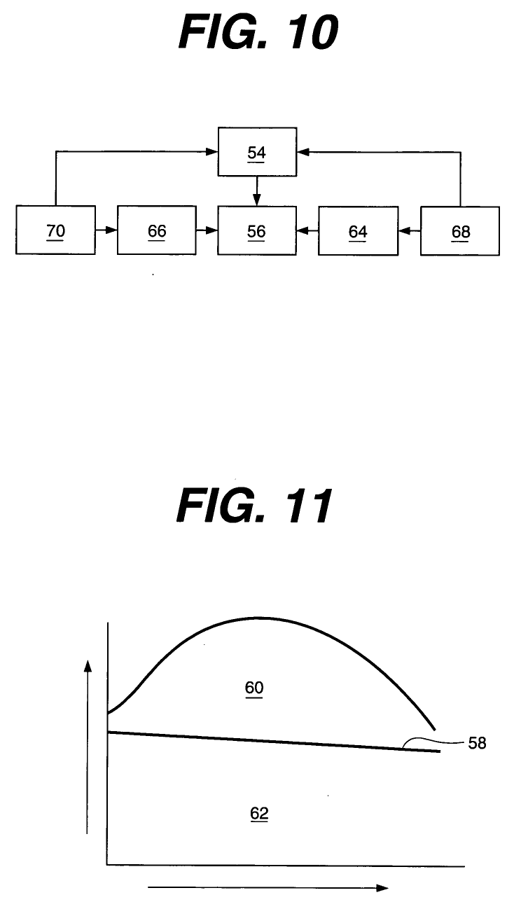

One method of operation of the engine 110 will be explained by reference to the flow diagram of FIG. 10. In a first control block 54, the at least one sensor 646 of the control system 642 senses at least one condition of the engine 110, such as a load condition, speed condition, or temperature condition. The at least one sensor 646 sends a signal to the ECU 644 delivering the status of the condition. In the remainder of the explanation of the method of operation illustrated in the flow diagram of FIG. 10, the at least one condition will be the load condition of the engine 110. However, in other methods, other conditions may be sensed and reported.

In a second control block 56, the ECU 644 compares the status of the load condition to a reference condition 58. The reference condition 58 may be either an upper threshold of a low load condition or a lower threshold of an upper load condition. In one embodiment, the reference condition 58 is approximately 50% engine load. In another embodiment, the reference condition 58 is between 40% engine load and 60% engine load. In another embodiment, the reference condition 58 is between 25% engine load and 75% engine load. One of ordinary skill in the art will recognize that the reference condition 58 may be chosen based upon the desired operation of the engine 110. In addition, the reference condition 58 may be dependent upon other conditions of the engine 110, as shown in the graph of FIG. 11. FIG. 11, having engine load along the Y-axis and engine speed along the X-axis, shows the reference condition 58 as dependent upon the engine load and the engine speed. The area 62 below the line indicating the reference condition 58 is defined as the low load condition. The area 60 above the line indicating the reference condition 58 is defined as the high load condition. If the load condition of the engine 110 reported by the at least one sensor 646 is less than the reference condition 58, i.e. the engine 110 is operating in the low load condition, the method proceeds to a third control block 64. If the load condition of the engine 110 is greater than the reference condition 58, i.e. the engine 110 is operating in the high load condition, the method proceeds to a fourth control block 66.

In the third control block 64, the control system 642 selects the first combustion mode of the engine 110. In one embodiment, the first combustion mode is the HCCI combustion mode. The control system 642 sends a signal to the fuel system 634 causing the fuel system 634 to deliver an HCCI fuel charge to the combustion chamber 206. The method then proceeds to a fifth control block 68. In the fifth control block 68, the control system 642 causes the exhaust stream of the engine 110 to not be in contact with the NOx adsorber 638. The exhaust stream may avoid the NOx adsorber 638 via the bypass path 640 of the exhaust system 802. The method then returns to the first control block 54.

In the fourth control block 66, the control system 642 selects a combustion mode other than the first combustion mode of the engine 110. The control system 642 may select the second combustion mode, which may be the diesel combustion mode. In the diesel combustion mode, the control system 642 sends a signal to the fuel system 634 causing the fuel system 634 to deliver a diesel fuel charge to the combustion chamber 206. The method then proceeds to a sixth control block 70. In the sixth control block 70, the control system 642 causes the exhaust stream to be in contact with the NOx adsorber 638. The method then returns to the first control block 54.

As the method of operation of the engine 110 diagrammed in FIG. 10 is followed, the engine 110 may switch operation from the first combustion mode to the second combustion mode. For example, if the engine 110 is running in HCCI combustion mode and the at least one sensor 646 senses a load condition in the first control block 54 that is greater than the reference condition 58, e.g., the upper threshold of the low load condition, the engine operation will be switched in the fourth control block 66 from the HCCI combustion mode to some other mode, such as the diesel combustion mode. Additionally, during operation the engine 110 may switch from the second combustion mode to the first combustion mode. For example, if the engine 110 is running in a non-HCCI combustion mode, such as the diesel combustion mode, and the at least one sensor 646 senses a load condition in the first control block 54 that is less than the reference condition 58, e.g., the lower threshold of the high load condition, the engine operation will be switched in the third control block 64 from the non-HCCI combustion mode to the HCCI combustion mode. Therefore, the switching of the engine 110 from one combustion mode to another is dependent upon a condition of the engine 110, e.g., the load condition of the engine 110.

One of ordinary skill in the art will recognize that the method set forth in FIG. 10 is one of several methods that may be used to control the operation of the engine 110. In addition, the graph of FIG. 11 is not the only method of determining when the engine 110 should switch from one combustion mode to another. For example, the reference condition 58 may not be linear or it may not depend upon speed. Alternatively, the information used to determine when the engine 110 should switch combustion modes may depend on other factors, such as engine speed and/or temperature, and may be depicted in other forms, such as a map, a lookup table and the like.

In another embodiment of a method of operation of the engine 110, the engine 110 operates in a first combustion mode during which combustion produces a first exhaust stream having a first concentration of NOx. The first concentration of NOx is less than or equal to a predetermined reference NOx concentration. Examples of the predetermined reference NOx concentration include, but are not limited to, 3 grams per brake-horsepower-hour, 1.5 grams per brake-horsepower-hour, and 0.2 grams per brake-horsepower-hour. Several factors may influence the value of the predetermined reference NOx concentration, including end-user specifications and government regulations, such as those promulgated by the United States Environmental Protection Agency. In one embodiment, the first combustion mode is an HCCI combustion mode, and in another embodiment, the first combustion mode is a partial-HCCI combustion mode.

In the method of operation of the engine 110, the engine 110 is switched to a second combustion mode during which combustion produces a second exhaust stream having a second concentration of NOx. The second concentration of NOx is greater than the predetermined reference NOx concentration. In one embodiment, the second combustion mode is not an HCCI combustion mode. For example, the second combustion mode may be a diesel combustion mode.

In the method of operating the engine 110, the second exhaust stream is directed into contact with at least one NOx adsorber 638. While the second exhaust stream is in contact with the at least one NOx adsorber 638, NOx is removed from the second exhaust stream to create a treated exhaust stream having a concentration of NOx that is less than or equal to the predetermined reference NOx concentration.

In one method of operation of the engine 110, the first exhaust stream may bypass the at least one NOx adsorber 638, such as via the bypass path 640 of the exhaust system 802. An alternative method of operation includes directing the first exhaust stream into contact with the at least one NOx adsorber 638. In this alternative method, the at least one NOx adsorber may be regenerated when the at least one NOx adsorber is in contact with the first exhaust stream. Such regeneration may be accomplished by adjusting the first combustion mode to run rich. Such adjustment of the operation of the first combustion mode may be controlled by the control system 642. In addition, the switching of operation between the first combustion mode and the second combustion mode may be controlled, as discussed above, by the control system 642.

The capabilities of the engine 110 a) to operate selectively in more than one combustion mode and b) to selectively incorporate a NOx adsorber 638 to treat the exhaust stream of the engine 110 enables the strengths of both NOx adsorber technology and HCCI combustion to be utilized while avoiding many of the weaknesses. By operating the engine 110 in HCCI combustion mode primarily at low load or low temperature conditions, the engine 110 will not face the high cylinder pressures caused by high load HCCI combustion. Therefore, engine components having commonly used material compositions may be used in the engine 110. In addition, the aforementioned significant structural changes, such as the introduction of mechanisms for varying the compression ratio of the engine 110, may not need to be incorporated.

Because HCCI combustion produces lower levels of emissions than standard diesel combustion, the NOx adsorber 638 may not need to treat the exhaust stream created by the HCCI combustion process. The NOx adsorber 638 need only be utilized when the engine 110 is operating at higher loads and/or temperatures in a non-HCCI combustion mode, such as the diesel combustion mode. Used in such a manner, the NOx adsorber 638 may have lower loadings of expensive PGM. Also, the difficulties of operating the NOx adsorber 638 at very low temperature conditions may be avoided. In addition, because the NOx adsorber 638 is not contacting the exhaust stream of the engine 110 during the entire running time of the engine 110, the rate of sulfur poisoning of the NOx adsorber 638 is reduced and the effective lifespan of the NOx adsorber 638 is increased.

It will be apparent to those skilled in the art that various modifications and variations can be made in the disclosed air and fuel supply system for an internal combustion engine without departing from the scope or spirit of the description. Other embodiments will be apparent to those skilled in the art from consideration of the specification and practice disclosed herein. It is intended that the specification and examples be considered as exemplary only.

1. A method of operating an internal combustion engine including at least one cylinder and a piston slidable in the cylinder, the method comprising:
supplying pressurized air from an intake manifold to an air intake port of a combustion chamber in the cylinder;
operating an air intake valve to open the air intake port to allow the pressurized air to flow between the combustion chamber and the intake manifold during a portion of a compression stroke of the piston; and
operating the engine in a homogeneous charge compression ignition (“HCCI”) combustion mode.

2. The method of claim 1, wherein operating an air intake valve comprises holding the intake valve open during a portion of the compression stroke with a hydraulic fluid system.

3. The method of claim 1, wherein operating the engine in the HCCI combustion mode comprises delivering an HCCI fuel charge into the combustion chamber of the engine.

4. The method of claim 3, wherein delivering the HCCI fuel charge includes delivering a first quantity of fuel into the combustion chamber at a first angle of dispersion and delivering a second quantity of fuel into the combustion chamber at a second angle of dispersion.

5. The method of claim 3, wherein delivering the HCCI fuel charge includes creating a substantially homogeneous mixture of air and fuel outside of the combustion chamber and delivering the homogeneous mixture into the combustion chamber.

6. The method of claim 1, further comprising injecting fuel into the combustion chamber with a pilot injection and a main injection.

7. The method of claim 6, wherein the main injection begins during the compression stroke.

8. The method of claim 1, wherein supplying pressurized air includes providing a quantity of exhaust gas from an exhaust gas recirculation (“EGR”) system.

9. The method of claim 8, wherein providing a quantity of exhaust gas includes providing exhaust gas from a low pressure loop EGR system.

10. A variable compression ratio internal combustion engine, comprising:
an engine block defining at least one cylinder;
a head connected with the engine block, including an air intake port, and an exhaust port;
a piston slidable in each cylinder;
a combustion chamber being defined by the head, the piston, and the cylinder;
an air intake valve movable to open and close the air intake port;
an air supply system including at least one turbocharger fluidly connected to the air intake port;
an exhaust gas recirculation (“EGR”) system operable to provide a portion of exhaust gas from the exhaust port to the air supply system;
a fuel supply system configured to deliver a homogeneous charge compression ignition (“HCCI”) fuel charge to the combustion chamber; and
a variable intake valve closing mechanism configured to keep the intake valve open by operation of the variable intake valve closing mechanism.

11. The engine of claim 10, further comprising a hydraulic system configured to hold the intake valve open during a portion of the compression stroke.

12. The engine of claim 10, wherein the EGR system is a low pressure loop EGR system.

13. A method of controlling an internal combustion engine having a variable compression ratio, the engine having a block defining a cylinder, a piston slidable in the cylinder, a head connected with the block, the piston, the cylinder, and the head defining a combustion chamber, the method comprising:
pressurizing a mixture of air and recirculated exhaust gas;
supplying the air and exhaust gas mixture to an intake manifold of the engine;
maintaining fluid communication between the combustion chamber and the intake manifold during a portion of an intake stroke and through a portion of a compression stroke; and
delivering a homogeneous charge compression ignition (“HCCI”) fuel charge to the combustion chamber.

14. The method of claim 13, wherein delivering the HCCI fuel charge comprises delivering an early pilot quantity of fuel into the combustion chamber.

15. The method of claim 13, wherein delivering the HCCI fuel charge comprises delivering a first quantity of fuel into the combustion chamber at a first angle of dispersion and delivering a second quantity of fuel into the combustion chamber at a second angle of dispersion.

16. The method of claim 13, wherein delivering the HCCI fuel charge comprises creating a substantially homogeneous mixture of air and fuel outside the combustion chamber and delivering the homogeneous mixture into the combustion chamber.

17. The method of claim 13, further comprising causing an exhaust stream of the engine to contact a NOx adsorber.

18. The method of claim 13, further comprising injecting fuel into the combustion chamber with a pilot injection and a main injection.

19. A method of controlling an internal combustion engine having a variable compression ratio, the engine having a block defining a cylinder, a piston slidable in the cylinder, a head connected with the block, the piston, the cylinder, and the head defining a combustion chamber, the method comprising:
pressurizing a mixture of air and recirculated exhaust gas;
supplying the air and exhaust gas mixture to an intake manifold of the engine;
maintaining fluid communication between the combustion chamber and the intake manifold during a portion of an intake stroke and through a portion of a compression stroke;
operating the engine in a homogeneous charge compression ignition (“HCCI”) combustion mode; and
causing an exhaust stream of an engine to contact a NOx adsorber.

20. A method of operating an internal combustion engine including at least one cylinder and a piston slidable in the cylinder, the method comprising:
supplying a pressurized air from an intake manifold to an air intake port of a combustion chamber in the cylinder;
operating an air intake valve to open the air intake port to allow the pressurized air and exhaust gas mixture to flow between the combustion chamber and the intake manifold during a majority portion of a compression stroke of the piston; and
operating the engine in a homogeneous charge compression ignition (“HCCI”) combustion mode.

21. The method of claim 20, wherein the operating an air intake valve comprises holding the intake valve open during a portion of the compression stroke with a hydraulic fluid.

22. The method of claim 20, wherein operating the engine in the HCCI combustion mode includes delivering an HCCI fuel charge into the combustion chamber of the engine.

23. The method of claim 22, wherein the delivering the HCCI fuel charge includes delivering a first quantity of fuel into the combustion chamber at a first angle of dispersion and delivering a second quantity of fuel into the combustion chamber at a second angle of dispersion

24. The method of claim 22, wherein delivering the HCCI fuel charge includes creating a substantially homogeneous mixture of air and fuel outside of the combustion chamber and delivering the homogeneous mixture into the combustion chamber.

25. The method of claim 20, further comprising injecting fuel into the combustion chamber with a pilot injection and a main injection.

26. The method of claim 25, wherein the main injection begins during the compression stroke.

27. The method of claim 20, further comprising causing an exhaust stream of the engine to contact a NOx adsorber.
